(19) United States
(12) Patent Application Publication
(10) Pub. No.: US 2009/0187691 A1
(43) Pub. Date: Jul. 23, 2009

(54) Method for operation of a bus system

(75) Inventors: Ralf Huck, Grosskrotzenburg (DE); Tilo Merlin, Linsengericht (DE)

Correspondence Address: BUCHANAN, INGERSOLL & ROONEY PC, POST OFFICE BOX 1404, ALEXANDRIA, VA, 22313-1404, US

(73) Assignee: ABB AG, Mannheim (DE)

(21) Appl. No.: 11/976,455

(22) Filed: Oct. 24, 2007

(30) Foreign Application Priority Data
Oct. 25, 2006 (DE) 10 2006 050 135.7

(51) Int. Cl. G06F 13/366

(52) U.S. Cl. 710/114

(57) ABSTRACT

The disclosure relates to a method for operating a bus system, in which a plurality of subscribers communicate with one another over the same bus line and all subscribers are assigned a subscriber address from a limited address set. To avoid address conflicts, it is suggested that by each subscriber newly added to an existing bus system, the bus traffic will be monitored before the first send access to the bus with the current subscriber address, in order to form a list of already used subscriber addresses. The subscriber then assigns itself an address from the as yet unused address space according to a predefinable schema.

### RELATED APPLICATIONS

This application claims priority under 35 U.S.C. §119 to German Patent Application No. 10 2006 050 135.7 filed in Germany on Oct. 25, 2006, the entire contents of which are hereby incorporated by reference in their entireties.

### TECHNICAL FIELD

A method for operation of a bus system is disclosed.

### BACKGROUND INFORMATION

A bus system consists of a plurality of subscribers, who communicate with one another over a shared line, the line being divisible into sections, so-called segments. It is generally known that each subscriber in such a bus system is assigned an individual subscriber address, which uniquely identifies this subscriber in the bus system.

In particular in field bus systems, the maximum number of subscribers from the address set is limited by definition. Thus it is known from the book by Manfred Popp “Profibus-DP: Grundlagen, Tips und Tricks für Anwender [“Profibus DP: Basics, Tips and Tricks for Users”], Hüthig, Heidelberg, 1998”, that a Profibus system in the maximum configuration can include a maximum of 126 subscribers with the addresses 0 to 125.

It is known for the addresses to be selected by means of switches, in particular by use of DIP switches. While these selected addresses of the bus subscribers can be read at any time, address conflicts can only be avoided if the addresses of all active subscribers are known and the address of the new subscriber is set without errors by the operator. The human intervention inherent in this system is already error-prone. In addition to this, the physical size and the sensitivity to moisture of the DIP switch is a disadvantage. The latter property severely restricts the usage sites of bus subscribers equipped in this manner.

The use of software for selecting the addresses of the bus subscribers is additionally known. However, the address can only be input with software using a second, active bus system. It is thus not possible previously to read out or change the address without this second system. The free address space must likewise be known. Here too, incorrect operator inputs are not ruled out.

In bus systems, such as the Profibus, in which it is possible to add a further subscriber by separating the bus line and inserting a further bus connector, there is the latent risk that two subscribers in the bus system have the same subscriber address. If this doubly assigned subscriber address is called, both subscribers try to answer, causing an access conflict by the simultaneous access to the bus.

### SUMMARY

The disclosure is therefore based on the object of specifying a method for operating a bus system of this type, in which access conflicts from doubly assigned subscriber addresses are reliably avoided without further aids.

The invention is based on a bus system, in which a plurality of subscribers communicate with one another over the same bus line, and all subscribers are assigned a subscriber address from a limited address set. Each newly joining subscriber is also assigned an address, which for a subscriber installed for the first time is based on a factory setting, or, for a subscriber that has already been in service, comes from the past installation. The addresses are stored in a memory, and can be changed by instructions in a program.

The disclosure further assumes that in a bus system each subscriber also actually participates in the communication, and accordingly its address is detectably contained in the bus traffic in a time window that can be specified.

### DETAILED DESCRIPTION

According to the disclosure it is provided that by each subscriber newly added to an existing bus system, the bus traffic will be monitored for a defined time before the first send access to the bus with the current subscriber address. The subscriber addresses occurring in the bus traffic will be recorded. If the subscriber detects its own subscriber address in the bus traffic the subscriber's own address is independently replaced with a free subscriber address.

In detail, each newly added subscriber will first access the bus for reading only for a defined time, and record all subscriber addresses detected in the bus traffic.

After the defined time has elapsed, the newly added subscriber compares its address with the recorded subscriber addresses. If its subscriber address corresponds to one of the recorded subscriber addresses, the newly added subscriber independently changes its own address according to a predefinable schema.

According to a further feature of the disclosure, it is provided that the bus is monitored by the newly added subscriber before the first send access for the duration of at least one bus cycle. In bus systems in master/slave architecture in particular, each slave is addressed by the master at least once within a bus cycle. This means that after a complete bus cycle has elapsed, all addresses occurring in the bus system have occurred at least once in the bus traffic.

Further particulars and advantages of the disclosure will now be explained in more detail with reference to an example of a Profibus system. As already mentioned in the introductory part of the specification, a Profibus system in the maximum configuration can include a maximum of 126 subscribers with the addresses #0 to #125. Each subscriber is equipped at least with signal-processing means, in particular with a controller, and with storage means for retrievable storage of its address.

Within the embodiment it is assumed that subscribers with addresses #1 to #47 are already active in the bus system and communicate with one another. It is further assumed that another subscriber is being added to the bus system, and has the address #33 assigned from a previous installation. Accordingly, the address #33 is present in duplicate in the bus system under consideration.

The newly added subscriber with the address #33 monitors the bus for the duration of at least one bus cycle before the first send access to the bus, and records all subscriber addresses detected in this time. It will be found out from the bus traffic that the addresses #1 to #47 are already held by other active subscribers. The newly added subscriber thereupon independently replaces its own subscriber address with a subscriber address from the store of unused addresses #48 to #125 according to a predefinable schema.

A first embodiment of the disclosure provides for the subscriber address of the newly added subscriber to be replaced by the subscriber address that follows the highest occurring subscriber address. For this purpose, the highest identified subscriber address #47 is first of all determined and incremented. The current subscriber address #33 of the newly added subscriber is then replaced by the calculated subscriber address #48.

A further embodiment makes it possible to provide for the subscriber address of the newly added subscriber to be replaced by the subscriber address which is the highest possible, is valid and has not yet been used.

For this purpose, the highest valid subscriber address #125 in the address area is first of all determined, and its occupancy state is checked against the recorded subscriber addresses. If the highest valid subscriber address #125 is free, the current subscriber address #33 of the newly added subscriber is replaced by the highest valid subscriber address #125. If the highest valid subscriber address #125 is already in use, the highest free subscriber address from the recorded subscriber addresses is determined, and is assigned to the newly added subscriber.

A further embodiment makes it possible to provide for the subscriber address of the newly added subscriber to be formed with an offset from the highest subscriber address in use. An offset of 10 is then adopted. For this purpose, the highest identified subscriber address #47 is first of all determined, and is increased by the offset of 10. The current subscriber address #33 of the newly added subscriber is then replaced by the calculated subscriber address #57.

Another refinement of the disclosure makes it possible to provide for the bus to be monitored for a predeterminable, fixed time by the newly added subscriber before the first transmission access, which time lasts for sufficiently long that each subscriber in the bus system is addressed at least once in that system. This ensures, even for the bus systems which have no defined bus cycle, that each address of an active subscriber is unique in the bus system.

According to a further feature of the disclosure it is provided that the value range for the address space is selectable. As a result, for subscribers that are suitable based on their technical equipment for operation in various bus systems with different address spaces, the selection of addresses that are outside the permissible address space in the respective bus system is avoided.

After the newly added subscriber is linked to a valid address in the bus system for active communication, a further feature of the invention provides for assigning a new subscriber address operationally to the added subscriber. Advantageously, this means that in a configuration in which certain subscriber groups are assigned predetermined address ranges, the newly added subscriber can be classified, corresponding to its membership of one of the subscriber groups, into the associated address range.

It will be appreciated by those skilled in the art that the present invention can be embodied in other specific forms without departing from the spirit or essential characteristics thereof. The presently disclosed embodiments are therefore considered in all respects to be illustrative and not restricted. The scope of the invention is indicated by the appended claims rather than the foregoing description and all changes that come within the meaning and range and equivalence thereof are intended to be embraced therein.

What is claimed is:

1. A method for operating a bus system, in which a plurality of subscribers communicate with one another over the same bus line, and all subscribers are assigned a subscriber address from a limited address set, wherein
by each subscriber newly added to an existing bus system, the bus traffic will be monitored for a defined time before the first send access to the bus with the current subscriber address, the subscriber addresses occurring in the bus traffic will be recorded, and
if the subscriber detects its own subscriber address in the bus traffic the subscriber's own address is independently replaced with a free subscriber address.

2. The method as claimed in claim 1, wherein the subscriber address of the newly added subscriber is replaced by the subscriber address following the highest occurring subscriber address.

3. The method as claimed in claim 1, wherein the subscriber address of the newly added subscriber is replaced by the highest free subscriber address.

4. The method as claimed in claim 1, wherein the subscriber address of the newly added subscriber is replaced by a subscriber address which is determined by a predeterminable offset on the highest occurring subscriber address.

5. The method as claimed in claim 1, wherein the bus is monitored by the newly added subscriber before the first send access for the duration of at least one bus cycle.

6. The method as claimed in claim 1, wherein the bus is monitored by the newly added subscriber before the first send access for a predefinable fixed duration, which is sized such that each subscriber of the bus system is addressed at least once within this time.

7. The method as claimed in claim 1, wherein the value range for the address space is selectable.

8. The method as claimed in claim 1, wherein after a successful logon the added subscriber is assigned a new subscriber address operationally in the bus system.

9. The method as claimed in claim 4, wherein the bus is monitored by the newly added subscriber before the first send access for the duration of at least one bus cycle.

10. The method as claimed in claim 4, wherein the bus is monitored by the newly added subscriber before the first send access for a predefinable fixed duration, which is sized such that each subscriber of the bus system is addressed at least once within this time.

11. The method as claimed in claim 6, wherein the value range for the address space is selectable.

12. The method as claimed in claim 7, wherein after a successful logon the added subscriber is assigned a new subscriber address operationally in the bus system.

13. A bus system, in which a plurality of subscribers communicate with one another over the same bus line, and all subscribers are assigned a subscriber address from a limited address set, wherein
with each subscriber newly added to an existing bus system, the bus traffic being monitored for a defined time before the first send access to the bus with the current subscriber address, the subscriber addresses occurring in the bus traffic being recorded, and
when the subscriber detects its own subscriber address in the bus traffic the subscriber's own address is independently replaced with a free subscriber address.
